(19) United States
(12) Patent Application Publication
(10) Pub. No.: US 2023/0083098 A1
(43) Pub. Date: Mar. 16, 2023

(54) DRIVING ASSISTANCE DEVICE

(71) Applicant: KABUSHIKI KAISHA TOKAI RIKA DENKI SEISAKUSHO, Aichi (JP)

(72) Inventors: Naofumi KATO, Aichi (JP); Masanori KOSUGI, Aichi (JP); Hitoshi MURAKI, Aichi (JP); Tetsuya EGAWA, Aichi (JP)

(21) Appl. No.: 17/801,735

(22) PCT Filed: Feb. 26, 2021
(86) PCT No.: PCT/JP2021/007289

§ 371 Date: Aug. 23, 2022

(30) Foreign Application Priority Data
Mar. 3, 2020 (JP) 2020-035641

(51) Int. Cl. B60W 50/12; B60W 50/14; B60W 60/00

(52) U.S. Cl. CPC B60W 50/12; B60W 50/14; B60W 60/0059; B60W 2050/146; B60W 2540/229; B60W 2540/221; B60W 2540/16

(57) ABSTRACT

A driving assistance device includes a determination unit to, when a vehicle is transitioned to a movable state by start of driving assistance of the vehicle and a display related to the driving assistance is presented, determine whether or not a driver is in a drivable state in which the driver is capable of consciously performing an operation, based on whether or not the driver has recognized the display, and a control unit to allow acceptance of the operation when the determination unit determines that the driver is in the drivable state.

### CROSS-REFERENCES TO RELATED APPLICATIONS

The present patent application claims the priority of Japanese patent application No. 2020/035641 filed on Mar. 3, 2020, and the entire contents of Japanese patent application No. 2020/035641 are hereby incorporated by reference.

### TECHNICAL FIELD

The present invention relates to a driving assistance device.

### BACKGROUND ART

A parking assistance device is known in which a target parking spot is set by allowing a driver to move a target parking frame displayed together with a live picture of the area around the vehicle and then a vehicle is guided to the set target parking spot (e.g., see Patent Literature 1).

The parking assistance device operates such that it starts control for guiding the vehicle to the set target parking spot when the brake pedal is released by the driver after the target parking spot is set.

### CITATION LIST

### Patent Literature

Patent Literature 1: JP 2009/269462 A

### SUMMARY OF INVENTION

### Technical Problem

The parking assistance device disclosed in Patent Literature 1 may cause a problem that the vehicle may start moving against the driver's intention even when the brake pedal is unintentionally released by the driver.

It is an object of the invention to provide a driving assistance device which can prevent the unintentional operation from being accepted.

### Solution to Problem

According to an aspect embodiment of the invention, a driving assistance device comprises:
a determination unit to, when a vehicle is transitioned to a movable state by start of driving assistance of the vehicle and a display related to the driving assistance is presented, determine whether or not a driver is in a drivable state in which the driver is capable of consciously performing an operation, based on whether or not the driver has recognized the display; and
a control unit to allow acceptance of the operation when the determination unit determines that the driver is in the drivable state.

### Advantageous Effects of Invention

According to an embodiment of the invention, it is possible to provide a driving assistance device which can prevent the unintentional operation from being accepted.

### BRIEF DESCRIPTION OF DRAWINGS

FIG. 1A is an explanatory diagram illustrating the inside of a vehicle cabin in which a driving assistance device in an embodiment is arranged.

FIG. 1B is a block diagram illustrating the driving assistance device in the embodiment.

FIG. 2A is an explanatory diagram illustrating a driver viewed from a side to explain a line of sight calculated by a determination unit of the driving assistance device in the embodiment.

FIG. 2B is a block diagram illustrating a vehicle control system in the embodiment.

FIG. 3A is all explanatory diagram illustrating the periphery of an eyeball of the driver to explain how the determination unit of the driving assistance device in the embodiment determines that a display is recognized.

FIG. 3B is an explanatory diagram to explain a system to calculate the line of sight by the determination unit of the driving assistance device in the embodiment.

FIG. 4A is an explanatory diagram illustrating display shown on a meter display.

FIG. 4B is an explanatory diagram illustrating an indicator.

FIG. 4C is an explanatory diagram illustrating the lit indicator.

FIG. 5 is a flowchart showing an operation of the driving assistance device in the embodiment.

### DESCRIPTION OF EMBODIMENTS

### Summary of the Embodiments

A driving assistance device in an embodiment includes a determination unit to, when a vehicle is transitioned to a movable state by start of driving assistance of the vehicle and a display related to the driving assistance is presented, determine whether or not a driver is in a drivable state in which the driver is capable of consciously performing an operation, based on whether or not the driver has recognized the display, and a control unit to allow the acceptance of an operation when the determination unit determines that the driver is in the drivable state.

The driving assistance device does not accept an unintentional operation even if performed by the driver who does not recognize the display related to driving assistance. Therefore, it is possible to prevent the unintentional operation from being accepted as compared to when such a configuration is not adopted.

### Embodiment

### (General Configuration of a Driving Assistance Device 1)

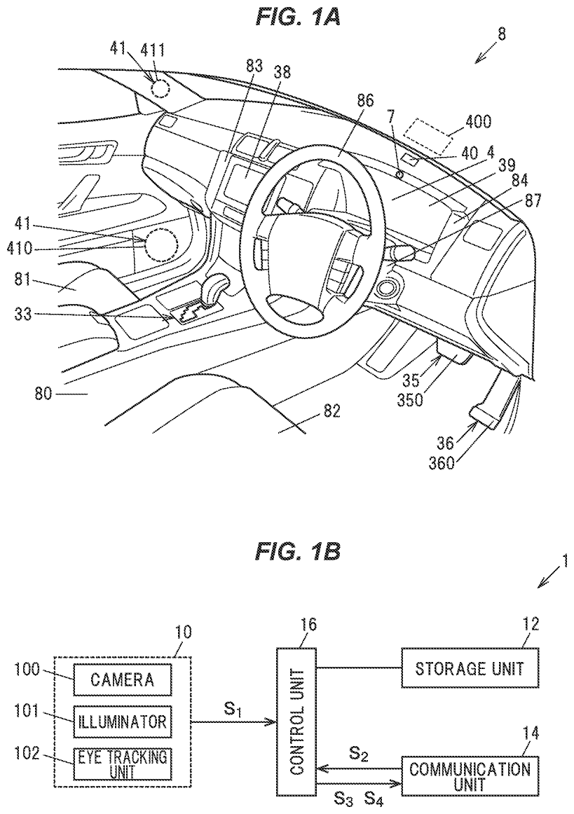

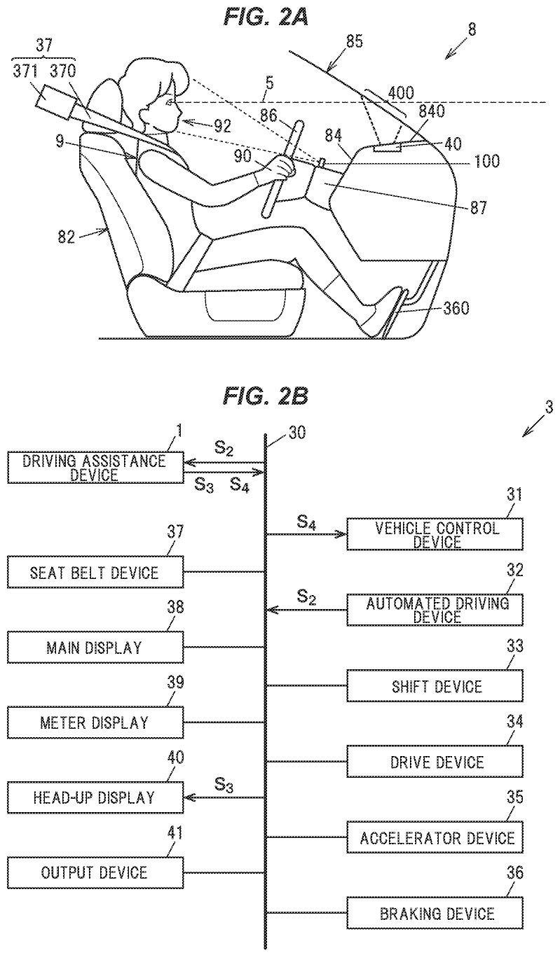

FIG. 1A is a diagram illustrating the inside of a vehicle cabin, and FIG. 1B is a block diagram illustrating the driving assistance device, FIG. 2A is an explanatory diagram illustrating a driver viewed from a side to explain a line of sight, and FIG. 2B is a block diagram illustrating a vehicle control system. In each drawing of the embodiment described below, a scale ratio may be different from an actual ratio. In addition, in FIGS. 1B and 2B, flows of main signals and information are indicated by arrows. Furthermore, the numeral range “A-B” means “not less than A and not more than B”.

The driving assistance device 1 is configured to not allow the acceptance of an operation until a driver recognizes a movable state when driving assistance by an automated driving function of a vehicle 8 is performed and the vehicle 8 is in the movable state.

In particular, as shown in FIGS. 1A, 1B and 2A, the driving assistance device 1 includes a determination unit 10 to, when the vehicle 8 is transitioned to the movable state by start of driving assistance of the vehicle 8 and a display 4 related to the driving assistance is presented, determine whether or not a driver is in a drivable state in which the driver is capable of consciously performing an operation, based on whether or not the driver has recognized the display 4, and a control unit 16 to allow the acceptance of an operation when the determination unit 10 determines that the driver is in the drivable state.

The control unit 16 does not allow the acceptance of an operation when the determination unit 10 determines that the driver is not in the drivable state.

The movable state is a state in which a shift device 33 of the vehicle 8 is shifted to a drive range (=D range) enabling forward movement or a reverse range (=R range) enabling backward movement.

The display 4 related to the driving assistance is presented by at least one of display by an image shown on a display device and display by lighting of an indicating lamp. The display device showing the display 4 is at least one of a main display 38, a meter display 39, and a head-up display 40 which are shown in FIG. 1A, The display 4 is shown on at least one of the meter display 39 and the head-up display 40 which require less driver's eye movement.

The driving assistance device 1 is included in a vehicle control system 3 of the vehicle 8, as shown in FIG. 2B. The vehicle control system 3 includes the driving assistance device 1, a vehicle control device 31, an automated driving device 32, the shift device 33, a drive device 34, an accelerator device 35, a braking device 36, a seat belt device 37, the main display 38, the meter display 39, the head-up display 40, and an output device 41. In the vehicle control system 3, the driving assistance device 1 and other devices, etc., are interconnected through an in-vehicle LAN (Local Area Network) 30.

### (Configuration of the Driving Assistance Device 1)

As shown in FIG. 1B, the driving assistance device 1 includes the determination unit 10, a storage unit 12, a communication unit 14, and the control unit 16.

The determination unit 10 calculates a line of sight 5 of the driver, and determines that the driver is in the drivable state when the line of sight 5 intersects the display 4 for a predetermined period of time. The predetermined period of time is preferably 0.5-2.0 seconds, more preferably 1.0-1.5 seconds. The predetermined period of time in the present embodiment is 1 second, as an example.

As an example, start of drive by the driver is determined by the automated driving device 32 and may be a combination of plural detections among detection of occupancy of a D seat 82, detection of fastening of a seat belt 370, detection of grip on a steering wheel 86, detection of operation on an accelerator pedal 350 and detection of depression of a brake pedal 360, or may be detection of a specified driver's driving position. The automated driving device 32 in the present embodiment determines start of drive when the conditions of detection of occupancy of the D seat 82 by a driver 9, detection of fastening of the seat belt 370, detection of grip on the steering wheel 86, and detection of depression of the brake pedal 360 are satisfied, as shown in FIG. 2A.

The detection of driving position is performed, e.g., by processing an image from a camera arranged in the vehicle cabin. The automated driving device 32 determines that the driver is in the specified driving position by the fact that, e.g., a face 92 of the driver 9 is facing forward, hands 90 of the driver 9 are gripping the steering wheel 86, and the brake pedal 360 is being depressed, etc., as shown in FIG. 2A. The grip on the steering wheel 86 may be detected by processing an image from a camera or may be detected by a sensor arranged on the steering wheel 86. An operation on the brake pedal 360 is detected by the braking device 36.

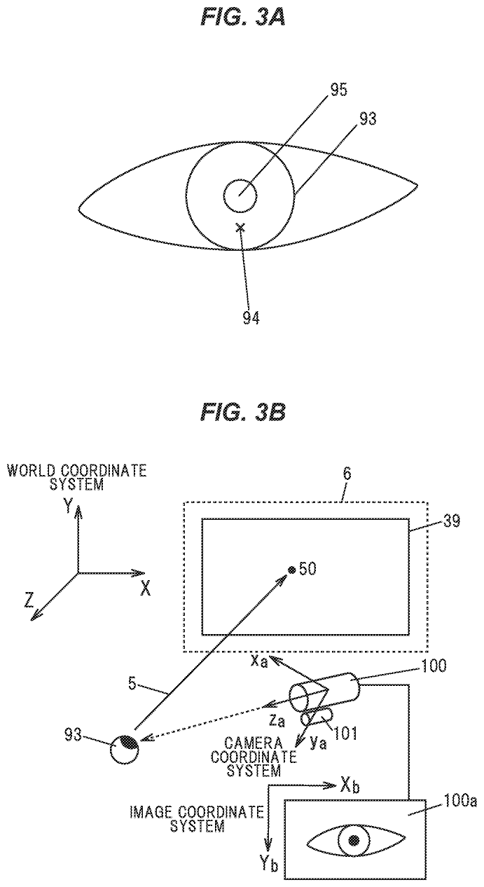

Next, driver's recognition of the display 4 based on detection of the line of sight 5 will be described below. FIG. 3A is a diagram illustrating the periphery of an eyeball of the driver, and FIG. 3B is a diagram to explain a system to calculate the line of sight. The display 4 is shown on the meter display 39.

As shown in FIG. 1B, the determination unit 10 includes a camera 100, an illuminator 101, and an eye tracking unit 102. The camera 100 is arranged on a ceiling or a steering column 87, etc., of the vehicle 8 so as to be able to capture an image of the driver's face. The illuminator 101 illuminates the face 92 of the driver 9 with near-infrared light at the time of capturing the image. The camera 100 and the illuminator 101 in the present embodiment are arranged on the steering column 87. The camera 100 periodically captures an image of the user. As a modification, the determination unit 10 may be configured to detect the line of sight 5 of the driver 9 by using an infrared sensor, etc.

The eye tracking unit 102 is, e.g., a microcomputer composed of a CPU (=Central Processing Unit) performing calculation and processing, etc., of the acquired data according to a stored program, and a RAM and a ROM (=Read Only Memory) as semiconductor memories, etc.

The eye tracking unit 102 in the present embodiment detects the line of sight 5 by a method using a Purkinje image 94, as an example. Next, detection of an intersection between the line of sight 5 of the driver 9 and a conscious region 6 will be described. The conscious region 6 is set as a plane including the meter display 39 on which the display 4 is shown.

The eye tracking unit 102 is configured to shine near-infrared light onto an eyeball 93 using the illuminator 101 and calculate an intersection 50, which is an intersection of the line of sight 5 and the conscious region 6, based on reflected light on a cornea surface (the Purkinje image 94) and a position of a pupil 95. In this regard, an area of the conscious region 6 is preferably set to an extent that does not significantly reduce a processing speed of the eye tracking unit 102.

In particular, the eye tracking unit 102 segments an image 100a captured by the camera 100 into regions with similar brightness and determines a pupil region from each segmented region based on the region shape using a pattern matching method, etc.

Next, the eye tracking unit 102 performs elliptical approximation of a set of contours of the pupil 95 by the minimum error sum of squares to obtain an ellipse center.

Next, the eye tracking unit 102 detects the Purkinje image 94 from within a certain range from the obtained ellipse center. Center coordinates of this Purkinje image 94 represent the center of gravity of the obtained region.

Next, the eye tracking unit 102 calculates the line of sight 5 from the obtained pupil 95 and Purkinje image 94, This calculation will be explained below.

Coordinates in an image coordinate system (a X_{b}Y_{b} coordinate system) shown FIG. 3B can be transformed to, e.g., coordinates (XYZ coordinates) in a world coordinate system when a Z coordinate in the world coordinate system is known. Meanwhile, the center of corneal curvature in a camera coordinate system (a XₐYₐZₐ coordinate system) is obtained from the Purkinje image 94.

Then, the eye tracking unit 102 calculates coordinates of the center of corneal curvature and those of the center of the pupil in the camera coordinate system, transforms the respective coordinates to coordinates in the world coordinate system, and thereby obtains a line-of-sight vector in the world coordinate system. When this line-of-sight vector intersects the conscious region 6 at the intersection 50, the determination unit 10 determines that driver's consciousness is directed to the conscious region 6, i.e., the driver 9 recognizes the display 4.

The method of detecting the line of sight is not limited to the example described above, and it is possible to use, e.g., a method in which the intersection 50 is calculated from an eye position or a face rotation angle, etc.

In addition, although the determination unit 10 determines that the driver 9 recognizes the display 4 when the line of sight 5 intersects the conscious region 6, it is not limited thereto. As a modification, the determination unit 10 may determine that the driver 9 recognizes the display 4 when the face 92 of the driver 9 is facing the meter display 39 showing the display 4.

The determination unit 10 generates recognition information S₁ indicating whether or not the driver 9 recognizes the display 4, and outputs it to the control unit 16.

The storage unit 12 is, e.g., a storage device such as a semiconductor memory, an HDD (=Hard Disk Drive), or an SSD (=Solid State Drive). The storage unit 12 in the present embodiment is a semiconductor memory, as an example.

The communication unit 14 is configured to be capable of communicating with the vehicle control device 31, etc., through the in-vehicle LAN 30.

The control unit 16 is, e.g., a microcomputer composed of a CPU performing calculation and processing, etc., of the acquired data according to a stored program, and a RAM and a ROM as semiconductor memories, etc. The ROM stores, e.g., a program for operation of the control unit 16. The RAM is used as, e.g., a storage area to temporarily store calculation results, etc. The control unit 16 also has, inside thereof, a means to generate a clock signal and operates based on the clock signal.

The control unit 16 outputs a display instruction signal S3 to show the display 4 based on notification instruction signal S₂ obtained through the communication unit 14, and also instructs the determination unit 10 to determine whether or not the driver 9 recognizes the display 4. The display instruction signal S₃ is input, through the communication unit 14 and the in-vehicle LAN 30, to the display device which presents the display 4. The notification instruction signal S₂ is output from, e.g., the automated driving device 32.

When, based on the recognition information S₁ obtained from the determination unit 10, the driver recognizes the display 4, the control unit 16 outputs an operation permission signal S₄ to allow the acceptance of an operation, to the vehicle control device 31 through the communication unit 14. This operation is an operation performed on, e.g., the shift device 33, the accelerator device 35, and the steering wheel 86.

The instruction to show the display 4 is given from the driving assistance device 1 in the present embodiment, but it is not limited thereto. It may be configured such that the automated driving device 32 outputs the notification instruction signal S₂ as well as a display instruction signal to the display device that shows the display 4.

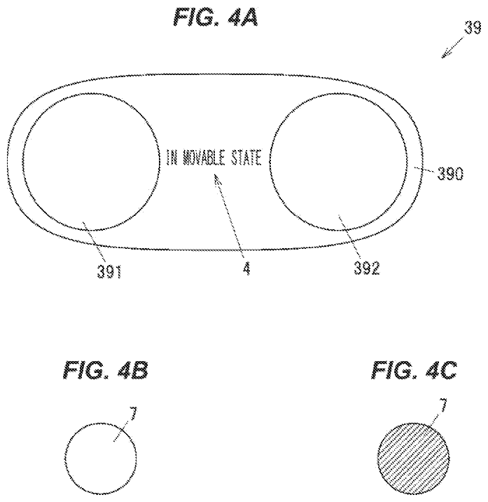

FIG. 4A shows an example of display shown on the meter display, FIG. 4B shows an example of an indicator, and FIG. 4C shows an example of the lit indicator.

As shown in FIG. 4A, the display 4 is shown in the middle between a speedometer image 391 and an information image 392 of the meter display 39. FIG. 4A shows the display 4 “IN MOVABLE STATE”.

In this regard, the display 4 is not limited to display by the display device, and may be lighting or flashing of an indicator 7 which is an indicating lamp. FIG. 4B shows a state before lighting, and FIG. 4C shows a lit state. The flashing state is a state in which the state of FIG. 4B and the state of FIG. 4C occur alternately and periodically. As shown in FIG. 1A, the indicator 7 is arranged on an instrument panel 84 at a position above the meter display 39.

As a modification, the indicator 7 may be configured to include, e.g., a light source and a mark illuminated by the light source. This mark is a design expressing the movable state, as an example.

### (Configuration of the In-Vehicle LAN 30)

The in-vehicle LAN 30 enables reciprocal exchange of signals and information, etc., between electronic devices connected using communications standard such as CAN (Controller Area Network) or LIN (Local Interconnect Network).

### (Configuration of the Vehicle Control Device 31)

The vehicle control device 31 comprehensively controls electronic devices mounted on the vehicle 8. The vehicle control device 31 has basic functions of the vehicle 8, e.g., an authentication function to authenticate an electronic key or a portable terminal, a function of unlocking doors after successful authentication, a function of controlling the drive device 34 according to an operation performed on the accelerator device 35, and a function of controlling the main display 38, the meter display 39 and the head-up display 40, etc.

Based on the recognition information S₁ output from the driving assistance device 1, the vehicle control device 31 accepts operations performed on the shill device 33, the accelerator device 35 and the steering wheel 86. The vehicle control device 31 does not allow the acceptance of operations on the shift device 33, etc., until the operation permission signal S₄ is input after the vehicle is transitioned to the movable state.

### (Configuration of the Automated Driving Device 32)

The automated driving device 32 controls automated driving functions of the vehicle 8. The automated driving functions include, e.g., a function of automated driving to a destination, a function of suppressing lane departure, a function of driving while keeping a distance to a preceding vehicle, a function of avoiding collision with surrounding obstacles, and a function of maintaining a set speed, etc.

The automated driving device 32 has a function of automatically shilling a transmission range of the shill device 33 to the D range or the R range to assist the driving of the driver after predetermined conditions based on driver's schedule for the day or frequent activities, or a parking spot of the vehicle 8, etc., are satisfied. These predetermined conditions are, e.g., when the parking spot is where the vehicle has been parked in the past, and when a destination predicted based on the schedule is a frequent destination, etc.

The driver's schedule for the day is, e.g., a schedule that is input to a mobile terminal of the driver and is shared with the automated driving device 32 through communication between the automated driving device 32 and the mobile terminal of the driver. Meanwhile, the frequent activities are calculated from history of operations performed on the vehicle 8, which is history based on the time and parking spots and recorded by the automated driving device 32.

The parking position is to store a location of the parked vehicle 8, with the GPS (=Global Positioning System) mounted on the vehicle 8 and a sensor to monitor the surroundings of the vehicle 8.

When the driver gets in the vehicle 8 and the predetermined conditions according to the schedule, frequency and parking spot, etc., described above are satisfied, the automated driving device 32 shifts the transmission range of the shift device 33 from the P range to the D range or the R range so as to get vehicle into the movable state. At this time, the automated driving device 32 causes the display 4 to be shown on, e.g., the meter display 39 to notify that the vehicle is in movable state.

### (Configuration of the Shift Device 33)

As shown in FIG. 1A, the shift device 33 is arranged on a floor console 80 located between a P seat 81 and the D seat 82. The shift device 33 includes a transmission of the vehicle 8 and is configured to change a combination of gears of the transmission. The vehicle 8 in the present embodiment is an AT (=Automatic Transmission) vehicle, Therefore, the shift device 33 mainly includes P range (=parking range), N range (=neutral range), D range (=drive range), and R range (=reverse range).

The P range is an operating position which is selected when parking the vehicle 8 and at which the gears in the transmission mesh together to prevent the vehicle 8 from moving. The N range is an operating position at which the gears in the transmission do not mesh and the vehicle 8 is in a movable state. The D range is an operating position at which the vehicle 8 moves forward. The R range is an operating position at which the vehicle 8 moves rearward.

The shift device 33 in the present embodiment is configured to automatically shift to each range under the control of the automated driving device 32.

### (Configuration of the Drive Device 34)

The drive device 34 is composed of an internal combustion engine gasoline engine, diesel engine), or a motor, or an internal engine and a motor. The drive device 34 is connected to a propeller shaft through the transmission, and wheels of the vehicle 8 on at least one of the front side and the rear side are rotationally driven by rotation of the propeller shaft.

### (Configuration of the Accelerator Device 35)

The accelerator device 35 includes the accelerator pedal 350 shown in FIG. 1A. The accelerator device 35 detects the depression amount of the accelerator pedal 350 and outputs information of the depression amount to the vehicle control device 31 or the automated driving device 32 through the in-vehicle LAN 30.

### (Configuration of the Braking Device 36)

The braking device 36 includes the brake pedal 360 shown in FIG. 1A. The braking device 36 applies a braking force to at least one of a hydraulic brake and a drum brake provided on each wheel, according to the depression amount of the brake pedal 360.

### (Configuration of the Seat Belt Device 37)

As shown in FIG. 2A, the seat belt device 37 includes the belt-shaped seat belt 370 to restrain the body of the driver 9 in the D seat 82, and a retractor 371 to wind out and wind up the seat belt 370.

The retractor 371 can wind out and wind up the seat belt 370 by using a motor.

### (Configuration of the Main Display 38)

As shown in FIG. 1A, the main display 38 is arranged on a center console 83 located diagonally in front of an occupant sitting in the P seat 81 and the driver sitting in the D seat 82. The main display 38 is a liquid crystal display or an organic EL (=Electro-Luminescence) display.

### (Configuration of the Meter Display 39)

The meter display 39 is arranged on the instrument panel 84 in front of the driver. As shown in FIG. 4A, the meter display 39 displays a display image 390 including the speedometer image 391 which is an image of the speedometer of the vehicle 8, and the information image 392 which shows a rev counter indicating revolution speed of an internal combustion engine or a fuel gauge, etc., in case that the drive device 34 is an internal combustion engine. The display 4 indicating the movable state is shown in the center of the display image 390. A plurality of such displays are prepared and switched according to the grade of the vehicle 8 or the driving mode, etc.,

### (Configuration of the Head-Up Display 40)

The head-up display 40 is arranged on an upper surface 840 of the instrument panel 84 to project an image onto a projection area 400 of a windshield 85. The projected image is, e.g., an image related to current speed or route guidance. The image related to route guidance is, e.g., an image of an arrow indicating a right or left turn or display of distance to a place to make a right or left turn. Alternatively, the head-up display 40 may be configured to have a display unit and to display an image on the display unit,

### (Configuration of the Output Device 41)

As shown in FIG. 1A, the output device 41 includes plural speakers 410 and 411 arranged on doors and pillars. Music and voice as well as warning sound, etc., are output from the speakers 410 and 411. As a modification, the driving assistance device 1 may provide notification by sound in addition to vibration. In addition, notification may be provided by display on the display device such as the main display 38, the meter display 39 and the head-up display 40 or by lighting or flashing of the indicating lamp.

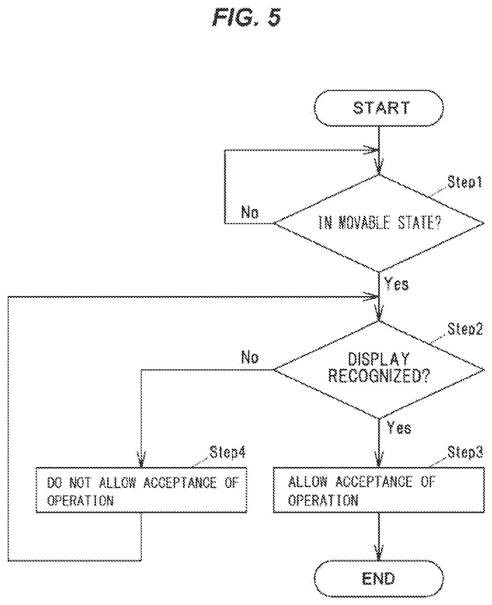

Next, an operation of the driving assistance device 1 in the present embodiment will be described in reference to the flowchart of FIG. 5. A case where the automated driving device 32 automatically controls the shift device 33 to shift to the D range or the R range after the driver sits in the D seat 82 will be described here.

### (Operation)

When it is “Yes” in Step 1, i.e., when the notification instruction signal S₂ is input through the communication unit 14, the control unit 16 of the driving assistance device 1 determines that the vehicle 8 is in the movable state (Step 1: Yes).

Next, the control unit 16 outputs the display instruction signal S3 to show the display 4 indicating the movable state, to the meter display 39 through the communication unit 14. Subsequently, the determination unit 10 determines whether or not the driver 9 has recognized the display 4. When the determination unit 10 determines, based on the calculated line of sight 5 of the driver 9, that the display 4 has been recognized (Step 2: Yes), the determination unit 10 outputs the recognition information S₁, which indicates that the display 4 has been recognized, to the control unit 16.

Next, in response to recognition of the display 4 by the driver 9 based on the obtained recognition information S₁, the control unit 16 outputs the operation permission signal S₄ to allow the acceptance of an operation (Step 3), and ends the operation.

Here, when it is not determined that the display 4 is recognized in Step 2 (Step 2: No), the control unit 16 does not allow the acceptance of an operation (Step 4) and proceeds to Step 2. The vehicle control device 31 in the present embodiment does not allow the acceptance of an operation unless the operation permission signal S₄ is input, but it is not limited thereto. It may be configured to disallow the acceptance of operations upon an input of an operation non-permission signal not to allow the acceptance of operations. This operation non-permission signal is output from the driving assistance device 1.

### (Effects of the Embodiment)

The driving assistance device 1 in the present embodiment can prevent the unintentional operations from being accepted. In particular, when the vehicle 8 is transitioned to the movable state, the driving assistance device 1 presents the display 4 indicating the movable state and determines whether or not the driver 9 has recognized this display 4, based on whether or not his/her line of sight 5 intersects the display 4 for a predetermined period of time. Then, once the driver 9 recognized the display 4, the driving assistance device 1 allows the acceptance of operations. Therefore, the unintentional operations even if performed by the driver who does not recognize the display 4 related to driving assistance are not accepted and it is thus possible to prevent the unintentional operations from being accepted, as compared to when such a configuration is not adopted.

The driving assistance device 1 does not allow the acceptance of operations unless the driver 9 recognizes the display 4. Therefore, an erroneous operation such as an unintentional operation can be prevented as compared to when such a configuration is not adopted.

Although some embodiment and modifications of the invention have been described, these embodiment and modifications are merely examples and the invention according to claims is not to be limited thereto. These new embodiment and modifications thereof may be implemented in various other forms, and various omissions, substitutions and changes, etc., can be made without departing from the gist of the invention. In addition, not all combinations of the features described in these embodiment and modifications are necessary to solve the problem of the invention. Further, these embodiment and modifications thereof are included within the scope and gist of the invention and also within the invention described in the claims and the range of equivalency.

### REFERENCE SIGNS LIST

1 DRIVING ASSISTANCE DEVICE
3 VEHICLE CONTROL SYSTEM
4 DISPLAY
5 LINE OF SIGHT
7 INDICATOR
8 VEHICLE
10 DETERMINATION UNIT
16 CONTROL UNIT
33 SHIFT DEVICE
38 MAIN DISPLAY
39 METER DISPLAY
40 HEAD-UP DISPLAY
102 EYE TRACKING UNIT

1. A driving assistance device, comprising:
a determination unit to, when a vehicle is transitioned to a movable state by start of driving assistance of the vehicle and a display related to the driving assistance is presented, determine whether or not a driver is in a drivable state in which the driver is capable of consciously performing an operation, based on whether or not the driver has recognized the display; and
a control unit to allow acceptance of the operation when the determination unit determines that the driver is in the drivable state.

2. The driving assistance device according to claim 1, wherein the control unit does not allow the acceptance of the operation when the determination unit that the driver is not in the drivable state.

3. The driving assistance device according to claim 1, wherein the display related to the driving assistance comprises at least one of display by an image shown on a display device and display by lighting of an indicating lamp.

4. The driving assistance device according to claim 1, wherein the determination unit calculates a line of sight of the driver and determines that the driver is in the drivable state when the line of sight intersects the display for a predetermined period of time.

5. The driving assistance device according to claim 4, wherein when the display is a display by the display device, the determination unit calculates an intersection of the line of sight and a conscious region set as a plane including the display device and thereby determines whether not the line of sight intersects the display.

6. The driving assistance device according to claim 5, wherein the determination unit calculates the intersection of the line of sight and the conscious region based on reflected light on a cornea surface of the driver and a position of a pupil.

7. The driving assistance device according to claim 6, wherein the determination unit shines near-infrared light onto an eyeball of the driver by an illuminator to provide the reflected light.

8. The driving assistance device according to claim 5, wherein the determination unit calculates the intersection of the line of sight and the conscious region from an eye position of the driver and a face rotation angle.

9. The driving assistance device according to claim 3, wherein when the driver's face is facing the display device, the determination unit determines that the driver is in the drivable state.

10. The driving assistance device according to claim 1, wherein the movable state comprises a state in which a shift device of the vehicle is shifted to a drive range enabling forward movement or a reverse range enabling backward movement.
